(19) United States
(12) Patent Application Publication
(10) Pub. No.: US 2025/0042812 A1
(43) Pub. Date: Feb. 6, 2025

(54) PRE- AND POST-TREATMENT METHODS FOR PRODUCING CARBON-NEGATIVE SUPPLEMENTARY CEMENTITIOUS MATERIALS BY DIRECT AIR CAPTURE AND SEQUESTRATION OF CARBON DIOXIDE

(71) Applicant: Wisconsin Alumni Research Foundation, Madison, WI (US)

(72) Inventors: Bu Wang, Madison, WI (US); Robert Anex, Madison, WI (US); Zhai Hang, Madison, WI (US)

(73) Assignee: Wisconsin Alumni Research Foundation, Madison, WI (US)

(21) Appl. No.: 18/793,164

(22) Filed: Aug. 2, 2024

Related U.S. Application Data
(60) Provisional application No. 63/576,463, filed on Aug. 3, 2023.

(51) Int. Cl. C04B 7/42; B01D 53/14; B01D 53/62; B01D 53/78; C04B 12/00

(52) U.S. Cl. CPC C04B 7/425; B01D 53/1475; B01D 53/1493; B01D 53/62; B01D 53/78; C04B 7/424; C04B 12/005; B01D 2251/304; B01D 2251/604; B01D 2257/504; B01D 2258/06

(57) ABSTRACT

A method for producing carbon negative supplementary cementitious materials utilizing a carbon mineralization-based direct air capture process. One version of the method comprises pre-treating a mineral feedstock with an alkaline solution, resulting in a pre-treated feedstock and an alkaline solution comprising dissolved alumina or silica. The pre-treated feedstock has enhanced carbonation reactivity in the subsequent carbon mineralization-based direct air capture process. Another version of the method comprises post-treating precipitates yielded from carbon mineralization-based direct air capture process of a mineral feedstock with an alkaline solution, resulting in a residue and an alkaline solution comprising dissolved alumina or silica. The alkaline solutions resulted from the pre- and post-treatments can be directly used as supplementary cementitious materials, or as a sorbent solution for carbon capture.

### CROSS-REFERENCE TO RELATED APPLICATIONS

Priority is hereby claimed to U.S. provisional application Ser. No. 63/576,463, filed Aug. 3, 2023, which is incorporated herein by reference.

### FEDERAL FUNDING STATEMENT

This invention was made with government support under DE-AR0001636 awarded by the US Department of Energy/ARPA-E and under 2132022 awarded by the National Science Foundation. The government has certain rights in the invention.

### BACKGROUND

Globally, cement production is responsible for the release of about 3 billion tons of carbon dioxide (CO₂) per year, about 8% of total CO₂ emissions (P. J. M. Monteiro et al., Towards Sustainable Concrete. Nat. Mater. 2017, 16 (7), 698-699; B. J. van Ruijven et al., Long-Term Model-Based Projections of Energy Use and CO₂ Emissions from the Global Steel and Cement Industries. Resour. Conserv. Recycl. 2016, 112, 15-36). Based on historic building growth rates, if produced using current methods, the emissions associated with cement production alone will account for as much as 40% of the world's carbon budget in 2050. About 10-30% of traditional Portland cement is currently replaced by coal fly ash as a supplementary cementitious material. This reduces the carbon footprint while generally improving the product and is mandated in many areas. However, the supply of coal fly ash is dwindling due to the decline of coal-fired power plants. Alternative supplementary cementitious materials suffer from high cost, low reactivity and/or high material variability.

A cement product called geopolymer cement has a lower carbon footprint than Portland cement, but it also requires large amounts of supplementary cementitious material whose supply is uncertain.

The scientific and patent literature regarding carbon dioxide capture and sequestration is extensive and covers several distinct approaches. For example, U.S. Pat. No. 5,100,633, issued Mar. 31, 1992, to Morrison, describes a process for scrubbing acid-forming gases, including sulfur dioxide and carbon dioxide, from flue gases. The untreated flue gas is first passed through a heat exchanger and then reacted with an aqueous, alkaline scrubbing solution. After the reaction, the solution, now containing dissolved salts with a precipitate of any insolubles, is passed through another heat exchanger to evaporate the water. This yields a solid residue of crystallized, carbon-containing salts.

Grander schemes have included fundamentally altering the carbon balance of the planet by increasing the alkalinity of the oceans. See H. Kheshgi (1995) “Sequestering Atmospheric Carbon Dioxide by Increasing Ocean Alkalinity,” Energy, 20(9): 912-922. Here, the author proposes adding calcium oxide to the oceans in sufficient quantity to increase the carbon dioxide-absorbing capacity of the oceans. Clearly such a far-reaching “solution” is not feasible.

Chemical reactions of gaseous carbon dioxide, water, and carbonate minerals have been extensively studied. For a thorough review, see Morse and Mackenzie, “Geochemistry of Sedimentary Carbonates” ISBN 978-0444873910, @ 1990, Elsevier Science (Amsterdam, Netherlands). These studies, though, are in the context of sedimentology, rather than carbon dioxide capture.

Thus, there remains a long-felt and unmet need for improved supplementary cementitious materials that can be used to generate concrete with a lower carbon footprint. There also remains a long-felt and unmet need for an economically feasible, scientifically feasible, and minimally disruptive method for capturing and sequestering man-made carbon dioxide.

### SUMMARY

The present disclosure addresses the aforementioned needs by providing methods to produce carbon negative cementitious materials utilizing a carbon mineralization-based direct-air capture process. In preferred versions, the methods use an aqueous carbonation cycle to capture CO₂ from the air while simultaneously processing mineral feedstocks such as industrial mineral wastes (IMW) to enhance their cementitious reactivity. The processed mineral feedstocks, storing the captured atmospheric CO₂ as solid carbonate (e.g., CaCO₃), can be used as cementitious material in conventional concrete to reduce Portland cement usage and enhance its durability. The processed mineral feedstocks can also fully replace Portland cement via an alkali activation cementation method. This concrete can be cast-in-place (on-site curing inside forms) or be precast for use in later construction. The concrete offers enhanced durability at equivalent strength, similar cost, and can be formed into reusable building components or recycled as carbon-negative aggregates at the end of life.

Thus, disclosed and claimed herein is a method of sequestering gascous carbon dioxide, while simultaneously generating supplementary cementitious materials. One version of the method comprises:
(a) contacting a solid feedstock comprising an oxide or a hydroxide with a first alkaline solution for a time and at a temperature wherein at least a portion of alumina or silica present in the solid feedstock is dissolved from the solid feedstock, thereby yielding a pre-treated feedstock and a second alkaline solution comprising dissolved alumina or silica;
(b) contacting the pre-treated feedstock with a first aqueous carbonate solution for a time, at a temperature, and under conditions wherein:
   (i) at least a portion of the oxide or hydroxide in the pre-treated feedstock is converted into a carbonate and wherein at least a portion of the carbonate so formed precipitates from the aqueous carbonate solution, to yield a precipitate; and
   (ii) an aqueous hydroxide solution is formed; and
(c) contacting the aqueous hydroxide solution of step (b)(ii) with gaseous carbon dioxide for a time, at a temperature, and under conditions wherein at least a portion of the gaseous carbon dioxide is sequestered into a second aqueous carbonate solution.

The method may further comprise using at least a portion of the second aqueous carbonate solution of step (c) as at least a portion of the first aqueous carbonate solution of step (b).

The first alkaline solution in step (a) may be a hydroxide solution. In certain embodiments, the first alkaline solution in step (a) has an OH-concentration of from about 0.1 M to about 2.0 M.

Optionally, the method further comprises precipitating at least a portion of the dissolved alumina or silica from the second alkaline solution and using the precipitated alumina or silica as a supplementary cementitious material.

The alumina or silica can be precipitated by any means now known in the art or developed in the future. Preferably, the precipitating comprises contacting the second alkaline solution with gaseous carbon dioxide for a time, at a temperature, and under conditions wherein at least a portion of the gaseous carbon dioxide is sequestered into a third aqueous carbonate solution. In certain embodiments, the method further comprises using at least a portion of the third aqueous carbonate solution as at least a portion of the first aqueous carbonate solution of step (b). Alternatively, the precipitating comprises contacting the second alkaline solution with a mineral acid.

Optionally, the method further comprises contacting the precipitate of step (b)(i) with a third alkaline solution for a time and at a temperature to extract from the precipitate at least a portion of any silica or alumina present therein, thereby yielding a fourth alkali solution comprising dissolved alumina or silica.

The solid feedstock in step (a) of the method may comprise a material selected from the group consisting of solid industrial waste, mafic rock, and ultramafic rock. The industrial waste may be selected from the group consisting of mine tailings, fly ash, bottom ash, slag, and crushed concrete.

Another version of the method comprises:
(a) contacting a solid feedstock comprising an oxide or a hydroxide with a first aqueous carbonate solution for a time, at a temperature, and under conditions wherein:
   (i) at least a portion of the oxide or hydroxide in the feedstock is converted into a carbonate and wherein at least a portion of the carbonate so formed precipitates from the aqueous carbonate solution, to yield a precipitate; and
   (ii) an aqueous hydroxide solution is formed;
(b) contacting the aqueous hydroxide solution of step (a)(ii) with gascous carbon dioxide for a time, at a temperature, and under conditions wherein at least a portion of the gaseous carbon dioxide is sequestered into a second aqueous carbonate solution; and
(c) contacting the precipitate of step (a)(i) with a first alkaline solution for a time and at a temperature wherein at least a portion of silica or alumina present in the precipitate is dissolved from the precipitate, thereby yielding a residue and a second alkaline solution comprising dissolved alumina or silica.

The method may further comprise using at least a portion of the second aqueous carbonate solution of step (b) as at least a portion of the first aqueous carbonate solution of step (a).

The first alkaline solution in step (c) may be a hydroxide solution. In certain embodiments, the first alkaline solution in step (c) has an OH⁻ concentration of from about 0.1 M to about 2.0 M.

Optionally, the method further comprises precipitating at least a portion of the dissolved alumina or silica from the second alkaline solution and using the precipitated alumina or silica as a supplementary cementitious material.

The alumina or silica can be precipitated by any means now known in the art or developed in the future. Preferably, the precipitating comprises contacting the second alkaline solution with gascous carbon dioxide for a time, at a temperature, and under conditions wherein at least a portion of the gaseous carbon dioxide is sequestered into a third aqueous carbonate solution. In certain embodiments, the method further comprises using at least a portion of the third aqueous carbonate solution as at least a portion of the first aqueous carbonate solution of step (a). Alternatively, the precipitating comprises contacting the second alkaline solution with a mineral acid.

The solid feedstock in step (a) of the method may comprise a material selected from the group consisting of solid industrial waste, mafic rock, and ultramafic rock. The industrial waste may be selected from the group consisting of mine tailings, fly ash, bottom ash, slag, and crushed concrete.

The objects and advantages of the invention will appear more fully from the following detailed description of the preferred embodiment of the invention made in conjunction with the accompanying drawings.

### BRIEF DESCRIPTION OF THE DRAWINGS

FIG. 1. A schema of an exemplary workflow of the disclosed method with pre-treatment of the mineral feedstock.

FIG. 2. A schema of an exemplary workflow of the disclosed method with post-treatment of precipitates yielded from carbonation of the mineral feedstock.

### DETAILED DESCRIPTION

### Definitions

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not.

All combinations of method steps as used herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the invention is not confined to the particular construction and arrangement of parts herein illustrated and described, but embraces such modified forms thereof as come within the scope of the claims.

The “mineral feedstock” or “solid feedstock” as used herein can comprise any composition comprising at least some mineral component. The mineral component can comprise silicates, oxides, sulfates, sulfides, carbonates, native elements, and halides, or any combination thereof. Minerals comprising silicon (e.g., silicates, silicate hydrates, silicon oxides, aluminosilicates) are preferred. Minerals comprising aluminum (e.g., aluminum oxides, aluminosilicates, hydroxyaluminates, aluminates, mixed oxides containing aluminum) are preferred. Minerals comprising calcium (e.g., calcium silicate, calcium aluminosilicate, calcium aluminates) are preferred. Minerals comprising magnesium or mixed calcium and magnesium (e.g., ground olivine, basalt, and serpentine) are preferred. The mineral feedstock can comprise an industrial mineral waste. “Industrial mineral waste” refers to any waste or byproducts of the processing of mineral-containing materials. Exemplary processes include mining, ore refining, mineral refining, fossil fuel refining, and fossil fuel combustion, among others. Exemplary industrial mineral wastes include waste rock, mill tailings, coal refuse, wash slimes, spent oil shale, coal ash (e.g., fresh coal ash, reclaimed coal ash, off-spec coal ash, fly ash, and bottom ash), slag (e.g., blast furnace slag, iron slag, steel slag, basic oxygen furnace slag, electric arc furnace slag, and boiler slag), cement kiln dust, ground glass, and recycled concrete, among others.

Unless explicitly specified to the contrary, the term “solution” is used herein to refer to an aqueous solution, wherein “aqueous” refers to containing water as a solvent or medium. In any solution herein, the solution preferably comprises water in an amount of at least 50% v/v, such as at least 55% v/v, at least 60% v/v, at least 65% v/v, at least 70% v/v, at least 75% v/v, at least 80% v/v, at least 85% v/v, at least 90% v/v, at least 95% v/v, or at least 99% v/v. For the avoidance of doubt, such volumes of the solutions account for only the volumes of the liquid portions of the solutions (including any molecules dissolved therein) and do not account for the volumes of any solids contacted, suspended, or dispersed therein.

The first aqueous carbonate solution preferably comprises dissolved carbonate exogenous to the feedstock. “Exogenous to the feedstock” is used herein to refer to an element that is included independently of the feedstock such that it is not derived or generated in situ from the feedstock. Any carbonate that is sparingly soluble to very soluble in water may be used as the exogenous carbonate in the first aqueous carbonate solution. Exemplary exogenous carbonates for including in the first aqueous carbonate solution include sodium carbonate, potassium carbonate, sodium bicarbonate, and potassium bicarbonate. It is generally preferred, but not required, that the first solution is saturated with the exogenous carbonate. In some versions, the first aqueous carbonate solution has an exogenous carbonate concentration from about 0.01 M to about 3.0 M or more. When a carbonate comprising sodium is used, the aqueous hydroxide solution formed comprises sodium hydroxide. Likewise, when a carbonate comprising potassium is used, the aqueous hydroxide solution formed comprises potassium hydroxide.

The first alkaline solution preferably comprises hydroxide exogenous to the feedstock. Any hydroxide that is sparingly soluble to very soluble in water may be used as the exogenous hydroxide in the first alkaline solution. Exemplary hydroxides include NaOH (sodium hydroxide), KOH (potassium hydroxide), LiOH (lithium hydroxide), RbOH (rubidium hydroxide), CsOH (cesium hydroxide), Ca(OH)₂ (calcium hydroxide), Sr(OH)₂(strontium hydroxide), and Ba(OH)₂ (barium hydroxide). Preferred hydroxides include alkali hydroxides, which include NaOH (sodium hydroxide), KOH (potassium hydroxide), LiOH (lithium hydroxide), RbOH (rubidium hydroxide), and CsOH (cesium hydroxide). The exogenous hydroxide is preferably included in the first alkaline solution in an amount effective to confer a pH greater than about 9, such as greater than about 9.5, greater than about 10, greater than about 10.5, greater than about 11, greater than about 11.5, greater than about 12, greater than about 12.5, or greater than about 13. The first alkaline solution preferably has such a pH when initially contacted with the feedstock (pre-treatment) or the carbonated precipitate of the feedstock (post-treatment) or within 10 minutes, 9 minutes, 8 minutes, 7 minutes, 6 minutes, 5 minutes, 4 minutes, 3 minutes, 2 minutes, or 1 minutes after initially contacting the feedstock (pre-treatment) or the carbonated precipitate of the feedstock (post-treatment). In some versions, the first alkaline solution has an exogenous hydroxide concentration from about 0.1 M to about 2.0 M of a strong base such as NaOH, KOH, etc.

The mineral feedstock is preferably in the form of a bulk particulate matter having a mean particle diameter no larger than about 4.75 mm, more preferably no larger than about 1 mm, and more preferably no larger than 100 micrometers. “Mean particle diameter” as used herein refers to the volume moment mean. Particle sizes above and below these values are explicitly within the scope of the method. Smaller particle sizes are preferred because it increases the available surface area, which increases the rate and efficiency of the carbonation reaction. Mean particle size can be determined by any number of conventional methods, such as sieving analysis, laser diffraction, and dynamic light scattering. These are conventional methods and well known to those skilled in the art.

The “carbon dioxide” or “gaseous carbon dioxide” as used herein can be mixed with any other gases in any proportion and be at any pressure. Atmospheric pressure or greater is preferred. In some versions, the gaseous carbon dioxide is provided in the form of air. In some versions, the gaseous carbon dioxide is provided in a more concentrated form.

### Carbon Mineralization-Based Direct Air Capture Process

Mineralization of carbon dioxide using industrial wastes is being actively studied to reduce carbon dioxide emissions to the atmosphere. Conventional sequestration methods consist of either single-step direct carbonation approaches or multi-step indirect carbonation to produce precipitated calcium carbonate. A typical indirect carbonation process involves a dissolution step to extract calcium, preferably in an acidic environment, which is followed by a calcium carbonate precipitation step. Often, an intermittent pH-swing step is required to increase leachate pH and facilitate carbonate precipitation.

A carbon mineralization-based direct air capture process has been developed based on the following chemical reactions:
2CaO·SiO₂+2Na₂CO₃+2H₂O→2CaCO₃↓+SiO₂+4NaOH CO₂+4NaOH→2Na₂CO₃+2H₂O.

Two underlying principles make the method less energy-intensive than existing schemes and thus more economically attractive:
1) Carbonation of calcium oxides, silicates and aluminates using sodium carbonate or potassium carbonate solutions increases the pH of the aqueous reaction solution due to the generation of soluble sodium hydroxide or potassium hydroxide.
2) Absorption of the carbon dioxide from dilute streams into sodium hydroxide solution (˜pH>12) is efficient and regenerates sodium carbonate and/or potassium carbonate, which is then recycled.

The method carbonates the alkaline industrial residues such as coal ashes, iron and steel slags, etc., using dilute carbon dioxide streams such as flue gas from power plants, carbon dioxide from biogas plants, or natural gas processing plants, to name a few.

In a preferred version of the method, a solid feedstock, such as industrial alkaline residues, is reacted with an aqueous solution of a carbonate, such as sodium carbonate/bicarbonate solution and/or potassium carbonate/bicarbonate solution, and the like. Preferably the solution is saturated with the carbonate. The method may proceed, though, using a solution that is less than saturated with the carbonate. The solution may have a carbonate concentration of from about 0.01 M to about 3.0 M. Higher concentrations, all the way to the solubility limit, are preferred.

The solid loading is optionally in the range of from about 1 to about 500 ml of carbonate solution per g of solid being treated. As a general principal, more solution per solid is preferred to increase the carbonation yield. The reaction temperature for carbonation is preferably from about 20° C. to about 100° C. Temperatures above and below this are within the scope of the method. Higher temperatures are generally preferred to increase the carbonation reaction rate and yield. The reaction is preferably conducted at atmospheric pressure.

In either batch or continuous reactors, the reaction time is generally from about 1 minute to about 60 minutes or more, such as up to 24 hours or more. Reaction times above and below this range are explicitly within the scope of the method. Generally, long reaction times maximize carbonate yield. Ultimate yield, though, depends on many factors, including the particle size distribution of industrial residue to be carbonated and other process parameters, such as the nature of the waste being treated. The carbonated residue is filtered/dewatered from the leachate using any method now known or developed in the future. Conventional hydrocyclone/gravity separation, centrifugal filtration, or other conventional filtration equipment may be used.

The filtered leachate, which is alkaline, is used to absorb carbon dioxide from flue gas or other carbon dioxide-rich stream. This is preferably done in an absorption column or other suitable reaction vessel. Elevated temperatures generally improve the CO₂ absorption rate, but only to a point. If the incoming gas stream to be treated is very hot, it might have to be cooled prior to treatment. Thus, incoming flue gas that is already at temperatures above about 100° C. and lower than about 200° C. may be directly absorbed without cooling. The CO₂ lean flue gas exiting from the absorption column is sent to the stack for release to the atmosphere. Any silicon or aluminum in the leachate is precipitated inside the absorption column as oxide and hydroxide, respectively, and are optionally separated by filtration. The filtered liquid is sodium bicarbonate/carbonate solution, which is available for recycling to the carbonation reactor. A fresh stream of sodium carbonate solution may optionally be added to make up for the solvent losses during filtration.

The carbonated solid residue obtained after carbon dioxide sequestration from industrial wastes contains calcium carbonate along with impurities such as silicates, aluminates, etc.

### Methods for Producing Carbon Negative Supplementary Cementitious Materials by Direct Air Capture and Sequestration of CO₂

Disclosed herein are novel methods for producing carbon negative supplementary cementitious materials (SCM) utilizing the carbon mineralization-based direct air capture process.

A first version of the method comprises pretreating the mineral feedstock such as industrial mineral wastes to improve its carbonation degree (pre-treatment). Before a feedstock is used in the above-described carbon mineralization-based direct air capture process, it is pretreated with an alkaline solution (e.g., NaOH) to enhance its carbonation reactivity. After the pretreatment, the feedstock is separated from the solution to yield a pre-treated feedstock and directly used for carbonation as part of the carbon mineralization-based direct air capture process. The pre-treatment enhances the feedstock reactivity by dissolving silica and alumina from the mineral particles and enriching their surface with readily carbonatable divalent ions (e.g., Ca and Mg). For instance, pretreating ground slag with 1 M NaOH solution for 1 hour significantly enhances its carbonation degree. CO₂ content obtained after 1-hour carbonation increased from 1.2 wt. % (without pretreatment) to 9.3 wt. % (with pretreatment). The alkaline solution for the pre-treatment can be used till the dissolved silica and alumina in the solution become near saturation, at which point the solution effectively becomes an alkali silicate/aluminate solution.

A second version of the method comprises treating the residue produced by the carbon mineralization-based direct air capture process with an alkaline solution (e.g., NaOH) to extract silica and alumina (post-treatment). For many feedstocks such as IMW, the carbonation reaction occurs rapidly, during which carbonates and silica/alumina are simultaneously generated near the mineral particle surfaces. Because the carbonation step of the carbon mineralization-based direct air capture process operates under basic conditions, the silica/alumina generated is not thermodynamically stable and will continue to dissolve. Their dissolution kinetics, however, are generally slower than carbonation. By leaving the carbonated feedstock in the carbonation solution (basic pH) or treating it with an alkaline solution in a separate step, silica/alumina can be extracted into the solution as aqueous species. This effectively produces an alkali silicate/aluminate solution.

The pre- and post-treatments are preferably conducted for a time from about 1 minute to about 60 minutes or more, such as up to 24 hours or more, a temperature from about 20° C. to about 100° C., and a pressure of about 1 atmosphere. Times, temperatures, and pressures above and below these values are explicitly within the scope of the method.

The alkaline solution used for the pre- and post-treatments preferably has an OH-concentration of from about 0.1 M to about 2.0 M. The pre- and post-treatments are preferably conducted at a loading from about 1 mL to about 500 mL of the alkaline solution per gram of the solid. Concentrations and liquid proportions of the alkaline solution above and below these values are explicitly included in the scope of the methods.

In a particular embodiment, the pre-treatment involves contacting the feedstock with the alkaline solution (e.g., >500 mM NaOH, liquid-to-solid ratio between 10-30 mL/g) up to 24 hours.

The alkali silicate/aluminate solution generated from the pre- and post-treatments can be directly used as an admixture for Portland cement concrete or a main ingredient for geopolymer concrete. This may involve precipitating the silica and alumina from the solution using a mineral acid. The silica and alumina contents of the solution can be modified by adjusting the pre- and post-treatments parameters. For instance, alumina was found to dissolve faster than silica with coal fly ash feedstocks. Shorter pre-treatment will therefore produce solutions with higher dissolved alumina content. Longer pre-treatment or post-treatment tends to produce solutions with higher dissolved silica content.

Alternatively, and preferably, the alkali silicate/aluminate solution generated from the pre- and post-treatments, which usually has a pH between 12-13, can be used as a sorbent solution for carbon capture. The capture can be done with air or point sources (e.g., flue gas from power plants or cement kiln; preferably comprising from 0.04 wt % to 100 wt % CO₂). The reaction between the solution and gaseous CO₂ forms Na₂CO₃ and precipitates silica/alumina. The precipitated silica and alumina can be used as SCM. The precipitated silica in particular can be used as a high-performance SCM. The resulted Na₂CO₃ solution produced can be introduced into the carbonation process as a makeup stream.

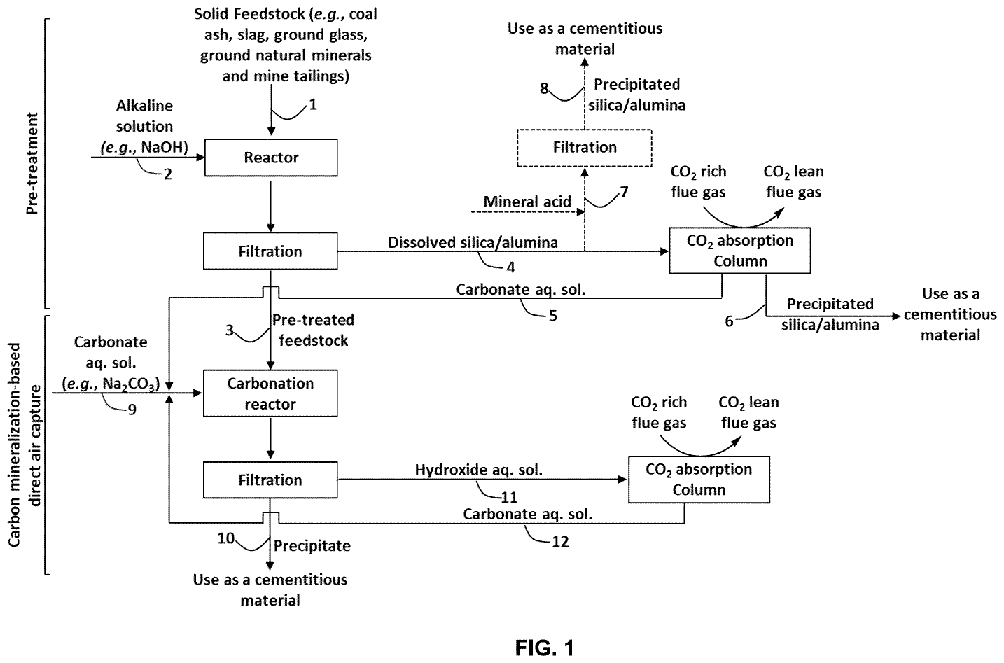

FIG. 1 shows a schema of an exemplary workflow of the disclosed method with pre-treatment of the mineral feedstock. In the upper section, the pre-treatment process is depicted, where the solid feedstock (stream 1) is contacted with an alkaline solution (e.g., NaOH; stream 2) in a reactor to dissolve silica and alumina from the mineral particles. After filtration, the process yields a pre-treated feedstock (stream 3) and an alkaline solution (stream 4) containing the dissolved silica and alumina. The alkaline solution (stream 4) is subsequently used as a sorbent solution for carbon capture in a CO₂ absorption column. Here, CO₂ from a CO₂ rich flue gas is captured and sequestered, producing an aqueous carbonate solution (stream 5) that can be used for carbonation in the carbon mineralization-based direct air capture process. During CO₂ capture and sequestration, the dissolved silica and alumina are precipitated (stream 6) and can then be used as SCM. Alternatively, as indicated by the dashed line in FIG. 1, the dissolved silica and alumina in stream 4 can be precipitated by adding a mineral acid (stream 7), and the precipitated silica and alumina (stream 8) can be used as SCM.

The lower section of FIG. 1 depicts the carbon mineralization-based direct air capture process using the pre-treated feedstock (stream 3). The process comprises contacting the pre-treated feedstock (stream 3) with an aqueous carbonate solution (e.g., Na₂CO₃; stream 9), resulting in a carbonated precipitate (stream 10) and an aqueous hydroxide solution (stream 11). The precipitate (stream 10), primarily composed of carbonates of divalent ions, such as CaCO₃ or MgCO₃, can be used as cementitious materials. The aqueous hydroxide solution (stream 11) is then used to capture and sequester CO₂ from a CO₂ rich flue gas, producing an aqueous carbonate solution (stream 12) that can be recycled to the carbonation step of the process.

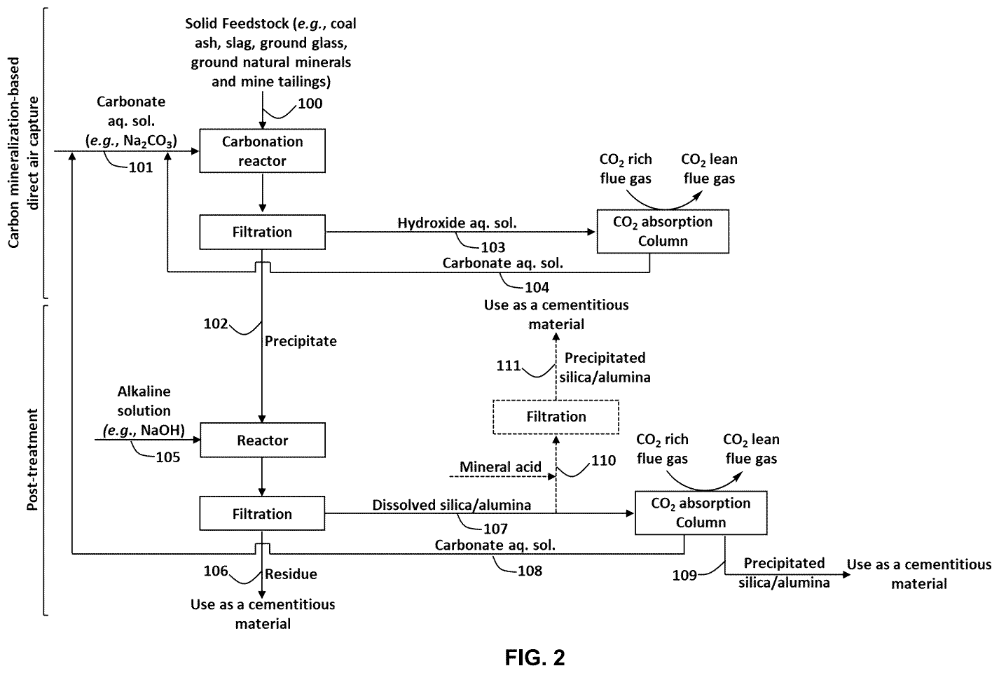

FIG. 2 shows a schema of an exemplary workflow of the disclosed method with post-treatment of precipitates yielded from carbonation of the mineral feedstock. The upper section of FIG. 2 depicts the carbon mineralization-based direct air capture process using the solid feedstock (stream 100). The process comprises contacting the solid feedstock (stream 100) with an aqueous carbonate solution (e.g., Na₂CO₃; stream 101), resulting in a carbonated precipitate (stream 102) and an aqueous hydroxide solution (stream 103). The aqueous hydroxide solution (stream 103) is then used to capture and sequester CO₂ from a CO₂ rich flue gas, producing a carbonate aqueous solution (stream 104) that can be recycled to the carbonation step of the process.

The lower section of FIG. 2 depicts the post-treatment process of the carbonated precipitate (stream 102). The process comprises contacting the carbonated precipitate (stream 102) with an alkaline solution (e.g., NaOH; stream 105) in a reactor to dissolve silica and alumina from the precipitate. After filtration, the process yields a residue (stream 106) and an alkaline solution (stream 107) containing the dissolved silica and alumina. The residue (stream 106), primarily composed of carbonates of divalent ions, such as CaCO₃ or MgCO₃, can be used as cementitious materials. The alkaline solution (stream 107) is subsequently used as a sorbent solution for carbon capture in a CO₂ absorption column. Here, CO₂ from a CO₂ rich flue gas is captured and sequestered, producing an aqueous carbonate solution (stream 108) that can be used for carbonation in the carbon mineralization-based direct air capture process. During CO₂ capture and sequestration, the dissolved silica and alumina are precipitated (stream 109) and can then be used as SCM. Alternatively, as indicated by the dashed line in FIG. 2, the dissolved silica and alumina in stream 107 can be precipitated by adding a mineral acid (stream 110), and the precipitated silica and alumina (stream 111) can be used as SCM.

The methods disclosed herein are appliable to Ca-rich IMW feedstocks such as coal ash, slag, and ground glass as well as Mg-rich and mixed Ca/Mg feedstocks such as ground natural minerals and mine tailings (e.g., ground olivine, basalt, and serpentine).

The methods as outlined herein can thereby generate one or more cementitious materials that can be used in downstream applications in the formation of concrete. The cementitious materials can be provided in any form, such as a solid form, a gel form, or a liquid form.

Some aspects of the disclosure pertain to the use of the cementitious materials of the disclosure to make concrete. The concrete can be made by mixing one or more of the cementitious materials of the disclosure with an activator in amounts and for a time effective to form the concrete. Exemplary activators include alkali activators, such as sodium hydroxide, potassium hydroxide, sodium silicate, and/or potassium silicate, among others. The cementitious materials can be used in the absence of Portland cement to generate geopolymer concrete or can be mixed as a supplementary cementitious material with Portland cement.

Reactions between the activator and the reactive aluminate and silicate yielded form the disclosed method form sodium aluminosilicate hydrate (NASH) networks that serve as the binder phase of the concrete (J. Davidovits. Geopolymer Chemistry and Applications, 5th Ed; Geopolymer Institute: Saint-Quentin, 2020; A. Kazemian et al., Quantitative Assessment of Parameters That Affect Strength Development in Alkali Activated Fly Ash Binders. Constr. Build. Mater. 2015, 93, 869-876). Concrete formed through this alkali activation process (referred to as geopolymer concrete) can be used in construction like traditional concrete (J. Davidovits. Geopolymer Chemistry and Applications, 5th Ed; Geopolymer Institute: Saint-Quentin, 2020; J. L. Provis. Geopolymers and Other Alkali Activated Materials: Why, How, and What? Mater. Struct. 2014, 47 (1), 11-25). Compared with traditional concrete, geopolymer concrete can offer enhanced durability at equivalent strength and similar cost (e.g., lower alkali silica reaction potential) (L. García-Lodeiro et al., Alkali-Aggregate Reaction in Activated Fly Ash Systems. Cem. Concr. Res. 2007, 37 (2), 175-183; C. You-zhi et al., Alkali Aggregate Reaction in Alkali Slag Cement Mortars. J. Wuhan Univ. Technol.-Mater Sci Ed 2002, 17 (3), 60-62; F. Pacheco-Torgal et al., Durability of Alkali-Activated Binders: A Clear Advantage over Portland Cement or an Unproven Issue? Constr. Build. Mater. 2012, 30, 400-405), higher resistance to chloride and sulfate ingression and damages (J. Zhang et al., Durability of Alkali-Activated Materials in Aggressive Environments: A Review on Recent Studies. Constr. Build. Mater. 2017, 152, 598-613; S. A. Bernal and J. L. Provis. Durability of Alkali-Activated Materials: Progress and Perspectives. J. Am. Ceram. Soc. 2014, 97 (4), 997-1008), higher resistance to freeze-thaw cycles (F. Pacheco-Torgal et al., Durability of Alkali-Activated Binders: A Clear Advantage over Portland Cement or an Unproven Issue? Constr. Build. Mater. 2012, 30, 400-405), and higher thermal stability (F. Pacheco-Torgal et al., Durability of Alkali-Activated Binders: A Clear Advantage over Portland Cement or an Unproven Issue? Constr. Build. Mater. 2012, 30, 400-405; T. W. Cheng and J. P. Chiu. Fire-Resistant Geopolymer Produced by Granulated Blast Furnace Slag. Miner. Eng. 2003, 16 (3), 205-210; M. B. Mohd Salahuddin et al., A Review on Thermophysical Evaluation of Alkali-Activated Geopolymers. Ceram. Int. 2015, 41 (3, Part B), 4273-4281).

The resulting geopolymer concrete of the disclosure stores atmospheric CO₂ in the form of CaCO₃ that remains stable even against heavy acid rain (D. J. Allen and G. F. Brent. Sequestering CO₂ by Mineral Carbonation: Stability against Acid Rain Exposure. Environ. Sci. Technol. 2010, 44 (7), 2735-2739). Geopolymer concrete precast elements can be designed for 100-year durability and to allow reuse at the end of first service life as elements for new buildings. Like traditional concrete, precast or cast-in-place geopolymer concrete can also be recycled into aggregates at the end of life.

What is claimed is:

1. A method of sequestering gaseous carbon dioxide, the method comprising:
(a) contacting a solid feedstock comprising an oxide or a hydroxide with a first alkaline solution for a time and at a temperature wherein at least a portion of alumina or silica present in the solid feedstock is dissolved from the solid feedstock, thereby yielding a pre-treated feedstock and a second alkaline solution comprising dissolved alumina or silica;
(b) contacting the pre-treated feedstock with a first aqueous carbonate solution for a time, at a temperature, and under conditions wherein:
(i) at least a portion of the oxide or hydroxide in the pre-treated feedstock is converted into a carbonate and wherein at least a portion of the carbonate so formed precipitates from the aqueous carbonate solution, to yield a precipitate; and
(ii) an aqueous hydroxide solution is formed; and
(c) contacting the aqueous hydroxide solution of step (b)(ii) with gaseous carbon dioxide for a time, at a temperature, and under conditions wherein at least a portion of the gaseous carbon dioxide is sequestered into a second aqueous carbonate solution.

2. The method of claim 1, further comprising using at least a portion of the second aqueous carbonate solution of step (c) as at least a portion of the first aqueous carbonate solution of step (b).

3. The method of claim 1, wherein in step (a) the first alkaline solution is a hydroxide solution.

4. The method of claim 1, wherein in step (a) the first alkaline solution has an OH⁻ concentration of from about 0.1 M to about 2.0 M.

5. The method of claim 1, further comprising precipitating at least a portion of the dissolved alumina or silica from the second alkaline solution and using the precipitated alumina or silica as a supplementary cementitious material.

6. The method of claim 5, wherein the precipitating comprises contacting the second alkaline solution with gaseous carbon dioxide for a time, at a temperature, and under conditions wherein at least a portion of the gaseous carbon dioxide is sequestered into a third aqueous carbonate solution.

7. The method of claim 6, further comprising using at least a portion of the third aqueous carbonate solution as at least a portion of the first aqueous carbonate solution of step (b).

8. The method of claim 5, wherein the precipitating comprises contacting the second alkaline solution with a mineral acid.

9. The method of claim 1, further comprising contacting the precipitate of step (b)(i) with a third alkaline solution for a time and at a temperature to extract from the precipitate at least a portion of any silica or alumina present therein, thereby yielding a fourth alkali solution comprising dissolved alumina or silica.

10. The method of claim 1, wherein the solid feedstock in step (a) comprises a material selected from the group consisting of solid industrial waste, mafic rock, and ultramafic rock.

11. The method of claim 10, wherein the industrial waste is selected from the group consisting of mine tailings, fly ash, bottom ash, slag, and crushed concrete.

12. A method of sequestering gaseous carbon dioxide, the method comprising:
(a) contacting a solid feedstock comprising an oxide or a hydroxide with a first aqueous carbonate solution for a time, at a temperature, and under conditions wherein:
(i) at least a portion of the oxide or hydroxide in the feedstock is converted into a carbonate and wherein at least a portion of the carbonate so formed precipitates from the aqueous carbonate solution, to yield a precipitate; and
(ii) an aqueous hydroxide solution is formed;
(b) contacting the aqueous hydroxide solution of step (a)(ii) with gaseous carbon dioxide for a time, at a temperature, and under conditions wherein at least a portion of the gaseous carbon dioxide is sequestered into a second aqueous carbonate solution; and
(c) contacting the precipitate of step (a)(i) with a first alkaline solution for a time and at a temperature wherein at least a portion of silica or alumina present in the precipitate is dissolved from the precipitate, thereby yielding a residue and a second alkaline solution comprising dissolved alumina or silica.

13. The method of claim 12, further comprising using at least a portion of the second aqueous carbonate solution of step (b) as at least a portion of the first aqueous carbonate solution of step (a).

14. The method of claim 12, wherein in step (c) the first alkaline solution is a hydroxide solution.

15. The method of claim 12, wherein in step (c) the first alkaline solution has an OH⁻ concentration of from about 0.1 M to about 2.0 M.

16. The method of claim 12, further comprising precipitating at least a portion of the dissolved alumina or silica from the second alkaline solution and using the precipitated alumina or silica as a supplementary cementitious material.

17. The method of claim 16, wherein the precipitating comprises contacting the second alkaline solution with gaseous carbon dioxide for a time, at a temperature, and under conditions wherein at least a portion of the gaseous carbon dioxide is sequestered into a third aqueous carbonate solution.

18. The method of claim 17, further comprising using at least a portion of the third aqueous carbonate solution as at least a portion of the first aqueous carbonate solution of step (a).

19. The method of claim 16, wherein the precipitating comprises contacting the second alkaline solution with a mineral acid.

20. The method of claim 12, wherein the solid feedstock in step (a) comprises a material selected from the group consisting of solid industrial waste, mafic rock, and ultramafic rock.

21. The method of claim 20, wherein the industrial waste is selected from the group consisting of mine tailings, fly ash, bottom ash, slag, and crushed concrete.
